(19) United States
(12) Patent Application Publication
(10) Pub. No.: US 2024/0152760 A1
(43) Pub. Date: May 9, 2024

(54) METHOD, APPARATUS, DEVICE AND MEDIUM FOR TRAINING AND APPLYING A CONTRASTIVE LEARNING MODEL

(71) Applicant: Beijing Youzhuju Network Technology Co., Ltd., Beijing (CN)

(72) Inventors: Hao Wu, Beijing (CN); Quan Cui, Beijing (CN); Boyan Zhou, Beijing (CN); Cheng Yang, Beijing (CN)

(21) Appl. No.: 18/472,601

(22) Filed: Sep. 22, 2023

(30) Foreign Application Priority Data
Oct. 31, 2022 (CN) 202211351724.1

(51) Int. Cl. G06N 3/088

(52) U.S. Cl. CPC G06N 3/088

(57) ABSTRACT

A method of training and applying contrastive learning model. The method includes obtaining a sample set and label information for training contrastive learning model, the sample set including a plurality of first samples of a first modality and a plurality of second samples of a second modality, the label information indicating a correlation between samples of the plurality of first samples and samples of the plurality of second samples; determining whether sample mixing is to be performed on the first modality or the second modality; in accordance with a determination that sample mixing is to be performed on the first modality, generating at least one first mixed sample of the first modality by mixing at least one pair of first samples among the plurality of first samples; and training the contrastive learning model at least based on the at least one first mixed sample and first mixed label information.

The present application claims priority to Chinese Patent Application No. 202211351724.1, titled “method, apparatus, device and medium for training and applying a contrastive learning model” filed on Oct. 31, 2022, the contents of which are hereby incorporated by reference in their entirety.

### TECHNICAL FIELD

The example embodiments of the present disclosure generally relate to machine learning, and in particular to a method, an apparatus, a device and a computer-readable storage medium for training and applying a contrastive learning model.

### BACKGROUND

With the development of machine learning technology, machine learning models can already be used to perform tasks in various application environments. Cross-modal contrastive learning is a machine learning method that utilizes a correlation between multimodal data (such as images, videos, text, audio, etc.) to learn characteristics of different modalities. In a process of contrastive learning, a contrastive learning model including encoders of multiple modalities will be constructed. The model training is completed using training data based on a contrastive learning loss function, so that the encoders of different modalities are obtained for extracting features from data of various modalities. Usually, the diversity of training samples can improve the performance of the model. In the case that training samples are limited or further improvement on the model performance is expected, it is desired to construct more different training samples on the basis of the existing training samples.

### SUMMARY

In a first aspect of the present disclosure, a method for training a contrastive learning model is provided. The method comprises obtaining a sample set and label information for training a contrastive learning model, the sample set comprising a plurality of first samples of a first modality and a plurality of second samples of a second modality, the label information indicating a correlation between samples of the plurality of first samples and samples of the plurality of second samples; determining whether sample mixing is to be performed on the first modality or the second modality for the sample set; in accordance with a determination that sample mixing is to be performed on the first modality, generating at least one first mixed sample of the first modality by mixing at least one pair of first samples among the plurality of first samples in the sample set; and training the contrastive learning model at least based on the at least one first mixed sample and first mixed label information, the first mixed label information indicating that a first mixed sample is related to a pair of second samples of the second modality that are related to a pair of first samples used for mixing the first mixed sample of the first modality.

In a second aspect of the present disclosure, a method for applying a contrastive learning model is provided. The method comprises obtaining the contrastive learning model trained according to the first aspect; and applying the contrastive learning model in at least one downstream task comprising at least one of the following: a first unimodal downstream task for the first modality, a second unimodal downstream task for the second modality, a cross-modal downstream task for the first modality and the second modality.

In a third aspect of the present disclosure, an apparatus for training a contrastive learning model is provided. The apparatus comprising an obtaining unit configured to obtain a sample set and a label information for training a contrastive learning model, the sample set comprising a plurality of first samples of a first modality and a plurality of second samples of a second modality, the label information indicating a correlation between samples of the plurality of first samples and samples of the plurality of second samples; a modality decision module configured to determine to perform sample mixing on the first modality or the second modality for the sample set; a first modality mixing module configured to generate at least one first mixed sample of the first modality by mixing at least one pair of first samples of the plurality of first samples in the sample set if it is determined to perform sample mixing on the first modality; and a first modality training module configured to train the contrastive learning model at least based on the at least one first mixed sample and a first mixed label information, the first mixed label information indicating that a first mixed sample is related to a pair of second samples of the second modality, and the pair of second samples is related to a pair of first samples for mixing the first modality of the first mixed sample.

In a fourth aspect of the present disclosure, an apparatus for applying a contrastive learning model is provided. The apparatus comprises a model acquisition module configured to obtain a contrastive learning model trained according to any of claims 1 to 9; and a model application module configured to apply the contrastive learning model in downstream tasks, which comprise at least one of the following: a first unimodal downstream task for the first modality, a second unimodal downstream task for the second modality, a cross-modal downstream tasks for the first modality and the second modality.

In a fifth aspect of the present disclosure, an electronic device is provided. The device comprises at least one processing unit; and at least one memory coupled to the at least one processing unit and storing instructions to be executed by the at least one processing unit, the instructions, when executed by the at least one processing unit, causing the device to perform the method of the first aspect and/or the method of the second aspect.

In a sixth aspect of the present disclosure, a computer-readable storage medium is provided. The medium has a computer program stored thereon which, when executed by a processor, performs the method of the first aspect and/or the method of the second aspect.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1A illustrates a schematic diagram of an example environment in which embodiments of the present disclosure can be implemented;

FIG. 1B illustrates a schematic diagram of cross-modal contrastive learning process;

FIG. 2A illustrates an example sample level mixing of a training sample set;

FIG. 2B illustrates label allocation strategy based on sample mixing in FIG. 2A;

FIG. 3 illustrates a block diagram of a process for training a contrastive learning model according to some embodiments of the present disclosure;

FIGS. 4A to 4C illustrate structure of a machine learning model based on contrastive learning according to some embodiments of the present disclosure;

FIG. 5A illustrates a block diagram of an apparatus for training a contrastive learning model according to some embodiments of the present disclosure;

FIG. 5B illustrates a block diagram of an apparatus for training a contrastive learning model according to some embodiments of the present disclosure; and

FIG. 6 illustrates a block diagram of an electronic device capable of implementing one or more embodiments of the present disclosure.

### DETAILED DESCRIPTION

The embodiments of the present disclosure will be described in more detail below with reference to the accompanying drawings. Although some embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for illustrative purposes and are not intended to limit the scope of protection of the present disclosure.

In the description of the embodiments of the present disclosure, the term “includes” and its variants are to be read as open terms that mean “includes, but is not limited to.” The term “based on” is to be read as “based at least in part on.” The terms “one embodiment” or “the embodiment” are to be read as “at least one embodiment.” The term “some embodiments” is to be read as “at least some embodiments.” Other definitions, either explicit or implicit, may be included below. As used herein, the term “model” may refer to a correlation between various data. For example, the above correlation may be obtained based on various technical solutions currently known and/or to be developed in the future.

It is to be understood that data involved in the present technical solution (including but not limited to the data itself, the acquisition or use of the data) should comply with requirements of corresponding laws and regulations and relevant rules.

It is to be understood that, before applying the technical solutions disclosed in various embodiments of the present disclosure, the user should be informed of the type, scope of use, and use scenario of the personal information involved in the subject matter described herein in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the subject matter described herein.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

As used herein, the term “model” may learn the correlation between corresponding inputs and outputs from training data, so that after training is completed, corresponding outputs may be generated for a given input. The model may be generated based on machine learning technology. Deep learning is a kind of machine learning algorithm that uses multiple layers of processing units to process inputs and provide corresponding outputs. The neural network model is an example deep learning based model. The “model” herein may also be referred to as “a machine learning model”, “a learning model”, “a machine learning network”, or “a learning network”, and these terms herein may be used interchangeably.

A “neural network” is a machine learning network based on deep learning. The neural network may process inputs and provide corresponding outputs, and the neural network typically includes an input layer, an output layer, and one or more hidden layers between the input and output layers. A neural network used in deep learning applications typically includes many hidden layers to increase the depth of the network. Each layer of a neural network are sequentially connected, so that outputs of a previous layer may be provided as inputs to a subsequent layer. The input layer receives inputs of the neural network, while outputs of the output layer serve as final outputs of the neural network. Each layer of the neural network includes one or more nodes (also referred to as processing nodes or neurons), and each node processes inputs from the previous layer.

Generally, machine learning may generally include three stages, namely a training stage, a testing stage, and an application stage (also referred to as an inference stage). During the training stage, a given model may be trained using a large amount of training data, iteratively updating values of parameters until the model may obtain consistent reasoning that meets the expected goals from the training data. Through training, the model may be considered to be able to learn the correlation between inputs and outputs (also referred to be as inputs to outputs mapping) from the training data. The parameters values for the trained model are determined. In the testing stage, testing inputs are applied to the trained model to test whether the model can provide correct outputs, thereby determining the performance of the model. In the application stage, the model may be used to process actual inputs and determine the corresponding outputs based on the parameter values obtained through training.

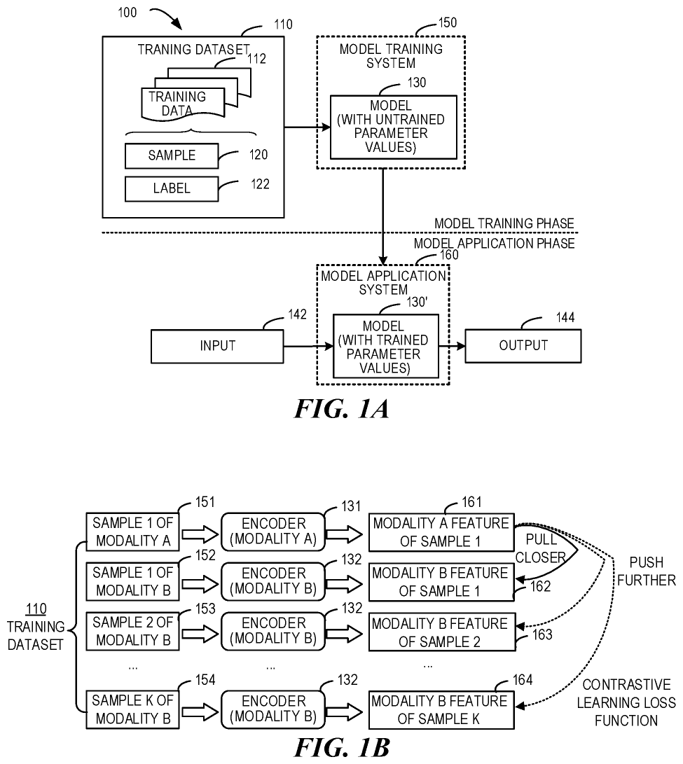

FIG. 1A illustrates a block diagram of an environment 100 capable of implementing multiple implementations of the present disclosure. In the environment 100 of FIG. 1, it is expected to train and apply such a machine learning model (i.e., a model 130), which is configured for various application scenarios, for example, for identifying image content, and so on. As shown in FIG. 1A, the environment 100 includes a model training system 150 and a model application system 160. The upper part of FIG. 1A illustrates a process of model training phase, and the lower part illustrates a process of model application phase. Before training, parameter values of the model 130 may have initial values or have pre-trained parameter values obtained through a pre-training process. The model 130 may be trained through forward propagation and backward propagation, and the parameter values of the model 130 may be updated and adjusted during the training process. After the training is completed, a model 130′ may be obtained. At this point, the parameter values of the model 130′ have been updated, and the model 130 may be used to achieve prediction tasks based on the updated parameter values in the model application phase.

In the model training phase, the model 130 may be trained using the model training system 150 based on a training dataset 110 that includes multiple training data 112. Here, each training data 112 may relate to a binary format and include a sample 120 and a label 122 related to the pending task. At this point, the model 130 may be trained using the training data 112 including the sample 120 and the label 122. Specifically, a large amount of training data may be utilized to iteratively perform the training process. After the training is completed, the model 130 may include knowledge about the tasks to be processed. In the model application phase, the model application system 160 may be used to call the model 130′ (at this time, the model 130′ has trained parameter values). For example, it is possible to receive input 142 that the model will process and output a corresponding answer to the pending task (i.e., output 144).

In FIG. 1A, the model training system 150 and the model application system 160 may include any computing system with computing capability, for example various computing devices/systems, terminal devices, servers, etc. The terminal devices may relate to any type of mobile terminals, fixed terminals or portable terminals, including a mobile phone, a desktop computer, a laptop computer, a notebook computer, a netbook computer, a tablet computer, a media computer, a multimedia tablet, or any combination thereof, including accessories and peripherals of these devices or any combination thereof. Servers include but are not limited to mainframes, edge computing nodes, computing devices in a cloud environment, etc.

It would be appreciated that components and arrangements in the environment shown in FIG. 1A are only examples, and a computing system suitable for implementing the example embodiments described in the present disclosure may include one or more different components, other components, and/or different arrangements. For example, although shown as separate, the model training system 150 and the model application system 160 may be integrated into a same system or device. The embodiments of the present disclosure are not limited in this regard. The following will continue to refer to the accompanying drawings to describe example embodiments of model training and model application respectively.

In some applications, the model 130 to be trained may include a contrastive learning model for multimodal. The contrastive learning model will be constructed to include different encoders for different modalities, used to learn feature representations for different modal data. FIG. 1B illustrates a schematic diagram of the cross-modal contrastive learning process. It is assumed that the contrastive learning model includes an encoder 131 for the first modality (referred to as “modality A”) and an encoder 132 for the second modality (referred to as “modality B”). The encoder 131 and 132 are respectively configured to extract features for the data of respective modal.

The training dataset 110 includes samples for modality A and samples for modality B. During the training process, samples from respective modalities of the training dataset 131 are input into the encoder 131 or 132 for feature extraction. For example, sample 1 151 of modality A is extracted through the encoder 131 to extract modality A feature 161 of sample 1; sample 1 152, sample 2 153, . . . , and sample K 154 of Modality B are extracted through the encoder 132 to extract modality B feature 162 of sample 1, modality B feature 163 of sample 2, . . . , and modality B features 164 of sample K. The labels in the training dataset 110 indicate that sample 1 151 of modality A is associated with sample 1 152 of modality B. For example, for cross-modal contrastive learning of images and texts, the association between image samples and text samples may refer to whether the text samples match the image samples, may describe the image samples, or vice versa.

For the extracted feature representations, encoder parameter values are updated by learning a loss function (for example, InfoNCE loss function) by comparison. In this process, parameter values are updated by pulling features of positive sample pairs to be closer to each other and pushing features of negative sample pairs away from each other. In contrastive learning, samples in one modality and the associated samples in another modality form a positive sample pair, for example, sample 1 151 of modality A and sample 1 152 of modality B in FIG. 1B; negative samples are formed by other samples in a training sample set (for example a training batch or a minibatch). For example, in modality B, except for sample 1 152, sample 1 151 of modality A and other samples of modality B, for example sample 2 152 of modality B, . . . , sample K 154, all form negative sample pairs. Therefore, based on the contrastive loss function, the modality A feature 161 of sample 1 and the modality B feature 162 of sample 1 will be pulled closer by updating the parameter values of the encoder 131 and 132, and the modality A feature 161 of sample 1 and the modality B feature 163 of sample 2 . . . the modality B feature 164 of sample K, etc. will be pushed further.

Note that in the following, for the convenience of discussion, a cross-modal contrastive learning model for two modalities will be discussed. However, it should be understood that the embodiments of the present disclosure may be similarly applied to contrastive learning models targeting more modalities.

In cross-modal learning, the richness of training samples may affect model performance. A richer training sample will result in better contrastive learning and higher performance model. In the field of cross-modal learning, there is currently no exploration of data augmentation techniques in this scenario.

In the unimodal learning task for images, for example image classification task, a scheme is proposed to enhance classification ability of a model by mixing image samples. The sample mixing scheme utilizes a weight α to weight a first image sample and a weight (1−α) to weight a second image sample, add the weighted two image samples and output a new image sample. For example, if a weight of 0.4 is applied to a first image classified as “cat” and a weight of 0.6 is applied to a second image classified as “dog”, a classification label of a mixed image may be represented as that the mixed image has a probability of 0.4 being classified as “cat” and 0.6 as “dog”. When calculating the loss, cross entropy may be calculated twice for the prediction results of the mixed image, once for the “cat” classification, and the other for the “dog” classification, based on the mixing weight α to perform weighted summation and obtain a weight as follows:

[symbol]

=−(α log P_{A}+(1−α)log P_{B}) (1)

where [symbol] represents a loss value, P_{A} is a probability of category A (for example “cat”) predicted by a classification model on and P_{B} is a probability of category B (for example “dog”) predicted by the classification model.

Sample mixing, as a way of training data enhancement, can effectively improve the robustness and performance of the model. Therefore, it is also expected to increase sample diversity through similar way in cross-modal learning. However, if unimodal sample mixing is directly applied to cross-modal contrastive learning, it may cause problems.

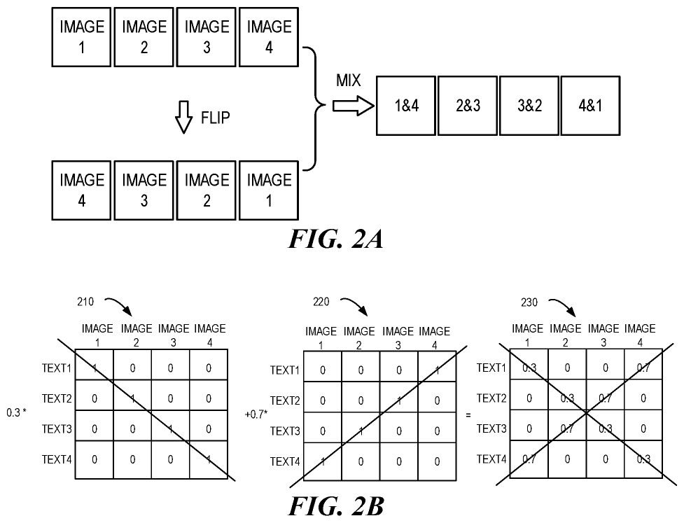

In cross-modal contrastive learning, the input of the model is a multimodal sample pair, for example a first sample of the first modality and a second sample of the second modality. The label information indicates a correlation between sample pairs. The sample pairs that are related to each other are positive sample pairs, while the other sample pairs are negative sample pairs. FIG. 2A illustrates an example sample level mixing of a training sample set. In the image text cross-modal scenario, for an image 1, an image 2, an image 3 and an image 4 in the training sample set, after flipping, a mixed image 1&4 may be obtained by mixing image 1 and image 4, a mixed image 2&3 may be obtained by mixing image 2 and image 3, a mixed image 3&2 may be obtained by mixing image 3 and image 2, and a mixed image 4&1 may be obtained by mixing image 4 and image 1. FIG. 2B illustrates the label allocation strategy based on the sample mixing in FIG. 2A. In FIG. 2B, a 0/1 correlation matrix 210 indicates a correlation of the four sample pairs before flipping, and a 0/1 correlation matrix 220 indicates a correlation of the four sample pairs after flipping. Among them, “1” indicates that a corresponding image sample is related to a text sample, and “0” indicates that the corresponding image sample is not related to the text sample. Assuming that a mixing weight α for text samples is 0.3, the correlation between the obtained image sample and the text sample is shown in matrix 230.

However, constructing positive and negative sample pairs for comparison on the basis of such sample mixing will cause problems. Assuming that the image 1 represents a “car” and the image 4 represents an “airplane”, and the mixing weight is 0.3, then the mixed image 1&4 represents a “car” of 0.3+an “airplane” of 0.7. After the text samples are mixed, the correlation between mixed image 1&4 (“car” of 0.3+“airplane” of 0.7) and text 1 (that is, the text description characterizing the car) should be 0.3, so the original matrix 210 needs to be weighted according to the mixing weight α, i.e., the right diagonal text mixing way in the matrix 230. However, for the correlation between the mixed image 4&1 (“car” of 0.7+“airplane” of 0.3) and the text 1 (that is, the text description characterizing the car) should be 0.7, then the flipped matrix 220 needs to be weighted according to the mixing weight (1−α), i.e. the left diagonal text mixing way in the matrix 230. This creates a contradiction in label allocation during sample mixing.

When attempting to apply sample mixing to multiple modalities simultaneously, assigning labels to the mixed samples is a challenging problem. Since contrastive learning is based on the contrastive loss function to drive model training, the goal of training is to narrow the distance between the image text sample pair and the 0/1 correlation matrix similar to FIG. 2B, that is, to make the correlation between the image 1 and the text 1 as large as possible (the similarity between the features of the two samples as large as possible), and to make the correlation between the image 1 and other text samples as small as possible. If two modalities are mixed simultaneously, the label information of the sample pairs (i.e., the 0/1 correlation matrix) needs to be reallocated, and such allocation is no longer a simple linear relationship. For example, for the mixed image 1&4 (“car” of 0.3+“airplane” of 0.7), if the corresponding text samples are also mixed, [“car” of 0.3+“airplane” of 0.7] may be described. However, there are also the mixed image 4&1 (“car” of 0.7+“airplane” of 0.3) in the mixed sample set. In this case, the text description [“car” of 0.3+“airplane” of 0.7] is not completely a negative sample of the mixed image 4&1. The correlation between the mixed image 4&1 and the text sample cannot be quantified in the case of cross-modal contrastive learning.

According to the example embodiments of the present disclosure, an improved scheme for training a contrastive learning model is provided. This scheme also enhances the diversity of training data based on sample mixing. However, in order to avoid the problem of difficult allocation of label information caused by simple application of sample level mixing, samples in one modality are mixed within each sample set on a sample set basis. A pair of mixed samples in another modality may be considered to be related to the mixed samples and form a positive sample pair together with the mixed samples. In some embodiments, the modality for performing sample mixing may be switched across different sample sets. Through this scheme, a multimodal sample mixing strategy may be introduced in cross-modal tasks to enhance sample diversity and improve model performance. In addition, by performing unimodal sample mixing within the sample set, the problem of inaccurate label allocation is avoided.

In the following, reference is still made to the accompanying drawings to describe some example embodiments of the present disclosure.

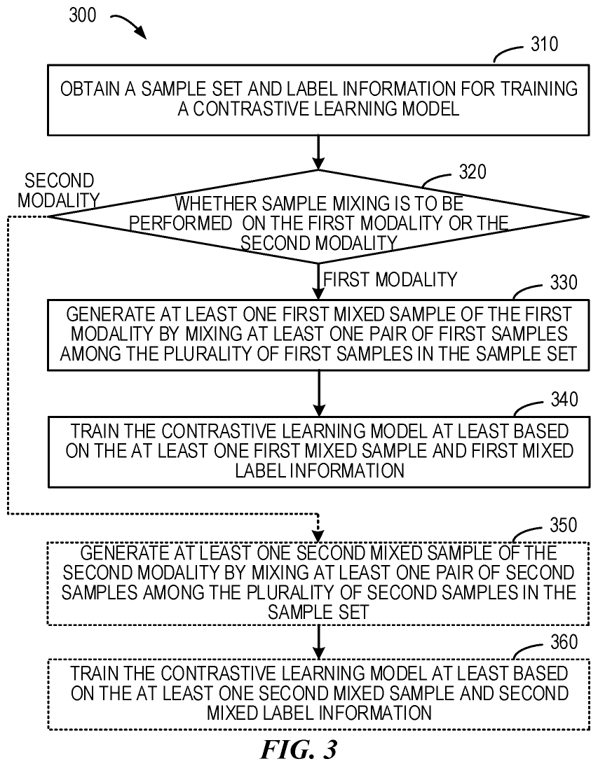

FIG. 3 illustrates a flowchart for training a contrastive learning model process 300 according to some embodiments of the present disclosure. The process 300 may be implemented at the model training system 150. For the convenience of discussion, the process 300 will be described with reference to environment 100 in FIG. 1.

At block 310, the model training system 150 obtains a sample set and label information for training a contrastive learning model. The sample set includes a plurality of first samples of the first modality and a plurality of second samples of the second modality, and the label information indicates a correlation between samples of the plurality of first samples and samples of the plurality of second samples.

In some embodiments, the first modality may include any of a plurality of modalities in the following: image, text, video, audio, and the second modality may include a further one of the multiple modalities. It will be understood that an example may be taken, where the first modality (sometimes represented as modality A) may be used for the image and the second modality (sometimes represented as modality B) may be used for the text, to describe in the following. Alternatively, or in addition, the first modality and the second modality may be exchanged. Alternatively, or in addition, the first modality and the second modality may also involve the same data format, for example, in an image processing (e. g., cropping, flipping, etc.) environment, both modalities may involve images. According to an exemplary implementation of the present disclosure, the first modality and the second modality may also involve other formats, including but not limited to image, text, video, audio, and the like.

In cross-modal contrastive learning, according to the label information, the first sample of the first modality is labeled as related to the second sample of the second modality, forming a positive sample in contrastive learning. In a sample set, for the first sample, it may form a negative sample pair with the other samples of the second modality. Similarly, for the second sample, the second sample may form a negative sample pair with the other samples of the first modality.

For the contrastive learning model to be trained, it usually includes at least a first encoder for the first modality and a second encoder for the second modality. Herein, the encoder, also known as a feature extractor, is configured to extract features of the input corresponding to the modal. The encoder for the first modality and the encoder for the second modality may be selected as a machine learning model or neural network suitable for processing the data of the corresponding modal.

For a contrastive learning model with an enhanced encoder with one modality, pre-training may be performed on the model using training data. For ease of understanding, a general cross-modal contrastive learning process will be described with reference to FIG. 3.

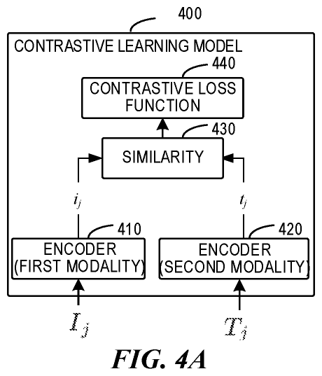

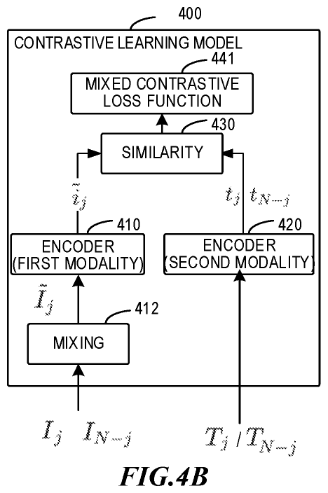

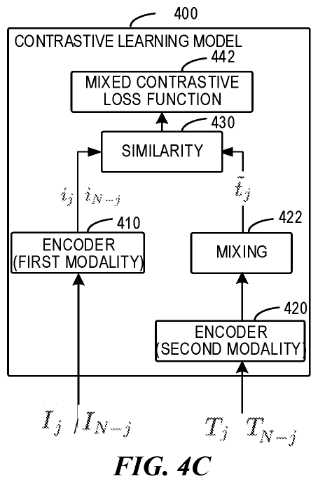

FIG. 4A illustrates a block diagram of the structure of a machine learning model based on contrastive learning according to some embodiments of the present disclosure. As shown in FIG. 4, a contrastive learning model 400 may include two encoders, an encoder 410 for the first modality (modality A) and an encoder 420 for the second modality (modality B). For the original sample, i.e., the sample without sample mixing, a training batch of samples may be obtained as a sample set. This sample set may include N pairs of samples that are related to each other. During training process, samples Iⱼ for the first modality and Tⱼ for the second modality may be input to encoders 410 and 420 respectively. The samples Iⱼ and Tⱼ are referred to as a pair of positive samples (Iⱼ, Tⱼ) in contrastive learning, that is, a pair of samples that are related to each other. The encoder 410 extracts the feature i j of sample represented as iⱼ=f_{I}(Iⱼ), where f_{I}( ) represents the processing of the encoder 410. The encoder 420 extracts the feature tⱼ of sample Tⱼ, represented as tⱼ=f_{T}(Tⱼ), where f_{T}( ) represents the processing of the encoder 420. Features may be represented as multidimensional vectors. Herein, “feature” is also referred to as characterization of input, encoding representation, vector representation, etc.

The contrastive learning model 400 will determine a similarity 430 between the two features provided by the encoders 410 and 420, and then determine a loss value of a contrastive loss function 440. The similarity between features may be calculated using any method that may characterize the similarity between vectors, for example. In the process of contrastive learning, based on the contrastive loss function 440, the encoder 410 and 420 may be gradually optimized by pulling closer the features (i.e., (iⱼ, tⱼ)) of the positive sample pairs that are related to each other (i.e., the sample pairs that are marked as related to each other) and pushing further the features (i.e., (iⱼ, t_{≠j}) and (i_{≠j}, tⱼ)) of the negative sample pairs that are not related to each other (i.e., the sample pairs that are not marked as related to each other). The contrastive loss function 440 may be, for example, an InfoNCE loss function or other contrastive loss function. The loss of all samples in the current training batch may be averaged, and the parameter values of the contrastive learning model 400, including those of the encoders 410 and 420, may be updated using a random gradient descent algorithm.

In the embodiments of the present disclosure, it is proposed to expand the training samples of the contrastive learning model by mixing samples on the original sample set. Unlike simply mixing each sample, in the embodiments of the present disclosure, only a unimodal sample is mixed in each sample set on a sample set basis.

Specifically, referring to FIG. 3, at block 320, the model training system 150 determines whether sample mixing is to be performed on the first modality or the second modality for the sample set. In some embodiments, the sample set includes samples required for a parameter update of the contrastive learning model. In some examples, the size of the sample set is the size of a training batch set for the contrastive learning model. A training batch may be in batches or minibatches. In the following, it is assumed that the sample set includes N sample pairs, that is, N first samples of first modality and N second samples of second modality.

Since unimodal sample mixing is performed in each sample set, for each sample set, it may be determined that sample mixing is to be performed on the first modality or the second modality. In a total training set of the contrastive learning model, multiple training sets may be constructed, for example training batches. The parameters of the contrastive learning model may be updated iteratively based on multiple training batches. In some embodiments, it is expected to achieve sample mixing for multiple modalities across training sets. Therefore, a sample set may be selected randomly for sample mixing of the first modality, and another sample set may be selected for sample mixing of the second modality.

In some embodiments, for the current training set, the model training system 150 may obtain a sampling value γ from a predetermined uniform distribution. This uniform distribution may, for example, obey any distribution function. The model training system 150 may compare the sampled value γ with a predetermined threshold. Based on the results, it is determined whether sample mixing is to be performed on the first modality or the second modality. For example, if a result of comparison between the sample value and the predetermined threshold value is a first comparison result, for example, if γ>0.5, it is determined to perform sample mixing on the first modality. Further, if the result of comparison between the sampling value and the predetermined threshold value is a second comparison result, for example, if γ≤0.5, it is determined to perform sample mixing on the second modality. That is, in a manner similar to tossing a coin, it is randomly determined to perform sample mixing on the first modality or the second modality.

Note that the comparison results assigned to the first modality and the second modality may also be interchanged. The comparison results here are only to make the selection of sample mixing between the first modality and the second modality random, or conform to some uniform distribution.

If it is determined that sample mixing is to be performed on the first modality, at block 330, the model training system 150 generates at least one first mixed sample of the first modality by mixing at least one pair of first samples among the plurality of first samples in the sample set. For the current sample set, if it is determined to perform mixing on the samples of the first modality, sample mixing will not be performed on the second samples of the second modality in the sample set.

FIG. 4B illustrates the structure of the machine learning model based on contrastive learning according to some embodiments of the present disclosure. In the example of FIG. 4B, it is assumed that the samples of the first modality in the sample set will be mixed, and the contrastive learning model 400 will be trained based on the mixed results. In this example, the mixing module 412 in the contrastive learning model 400 is configured to perform sample mixing for the first modality.

For multiple first samples of the first modality in the sample set, the mixing module 412 may use the mixing weight (represented as α) to mix a pair of first samples (for example image samples). In a sample set including N sample pairs, a pair of samples indicated by label information as being related to each other is represented as (Iⱼ, Tⱼ), for example (image sample j, text sample j).

In some embodiments, the mixing module 412 may number N samples of the first modality in the sample set in sequence, and then flip the corresponding samples in the numbering sequence to mix them to obtain N mixed samples of the first modality, as shown in the example in FIG. 2A. In this way, for a pair of samples Iⱼ and I_{N-j} (where the value of j may be from 1 to N), the mixed sample may be represented as Ĩⱼ=α*Iⱼ+(1−α)*I_{N-j}, where a is the mixing weight applied to the sample Iⱼ. In some embodiments, the mixing module 412 may also apply the mixing weight α to the sample I_{N-j} and apply (1−α) to the sample Iⱼ to obtain another mixed sample. Of course, in addition to flipping by number, a pair of samples may be selected to mix through other ways, for example the way of random sampling. For a set including N samples of first modality, it is not necessary to construct N mixed samples, but it is possible to construct fewer mixed samples. This may be selected according to the actual application needs.

In the embodiments of the present disclosure, for the mixed samples, the corresponding mixed label information may be determined. For at least one first mixed sample of the first modality, the corresponding first mixed label information indicates that a first mixed sample is related to a pair of second samples of the second modality, wherein the pair of second samples is also related to a pair of first samples used for mixing the first mixed sample of the first modality. For example, for a mixed sample Ĩⱼ, the samples Iⱼ and I_{N-j} used to mix the mixed sample and the corresponding second modality samples Tⱼ and T_{N-j} may be labeled as the relevant samples of the mixed sample Ĩⱼ.

At block 340, the model training system 150 trains the contrastive learning model at least based on the at least one first mixed sample and first mixed label information.

In the training process, the mixed samples of the first modality and the related samples of the second modality are input to the encoders 410 and 420 respectively, as shown in FIG. 4B. For the encoder 410 of the first modality, the feature \tilde{l}ⱼ=f (Ĩⱼ) corresponding to the mixed sample Ĩⱼ may be obtained. For the encoder 420 of the second modality, it still processes the second sample under the unmixed second modality, including samples Tⱼ and T_{N-j}. Of course, each second sample is sequentially input to the second encoder 420 to extract corresponding features tⱼ and t_{N-j}. The contrastive learning model 400 will determine the similarity 430 between the two features provided by the encoders 410 and 420, and then determine the loss value of the contrastive loss function (here referred to as the mixed contrastive Loss function) 441.

When determining the mixed contrastive loss function 441, the contrastive learning model 400 may determine a prediction related result in the second modality for the first mixed sample and determine the loss value of the mixed contrastive loss function based on the difference between the prediction related result and the first mixed label information. In some embodiments, the mixed contrastive loss function may include a first part from the first modality to the second modality (for example, the part from image to text) and a second part from the second modality to the first modality (for example, the part from text to image). For the first part of the mixed contrastive loss function, the contrastive learning model 440 may predict the features tⱼ and t_{N-j} of the related samples under the second modality based on the feature of the mixed sample Ĩⱼ. For the second part of the mixed contrastive loss function, the contrastive learning model 440 may predict the features of the mixed samples under the first modality based on the features tⱼ and t_{N-j} of the related samples under the second modality. When determining the loss value, the mixing weights of the samples used for mixing are also considered. In some embodiments, the loss of the mixed samples obtained from the current sample set may be averaged, and the parameter values of the encoder may be updated through a random gradient descent algorithm until the convergence goal is achieved.

In some embodiments, for the first part of the mixed contrastive loss function 441, the loss value may be determined as follows:

$${ℒ}_{\tilde{I} 2 T} = α * ( - \frac{1}{N} {\sum }_{j = 1}^{N} log \frac{exp ( {\tilde{ι}}_{j} \cdot {t}_{j} / τ )}{{\sum }_{k = 1}^{N} exp ( {\tilde{ι}}_{j} \cdot {t}_{k} / τ )} ) + ( 1 - α ) * ( - \frac{1}{N} {\sum }_{j = 1}^{N} log \frac{exp ( {\tilde{ι}}_{j} \cdot {t}_{N - j} / τ )}{{\sum }_{k = 1}^{N - 1} exp ( {\tilde{ι}}_{j} \cdot {t}_{N - k} / τ )} ) \qquad ( 2 A )$$

where [symbol] _{Ĩ2T} represents the loss value, and τ represents a predetermined hyperparameter (with similar meaning in the equations below). In some examples, the hyperparameter τ may be omitted.

In some embodiments, for the second part of the mixed contrastive loss function 441, the loss value may be determined as follows:

$${ℒ}_{2 T \tilde{I}} = α * ( - \frac{1}{N} {\sum }_{j = 1}^{N} log \frac{exp ( {t}_{j} \cdot {\tilde{ι}}_{j} / τ )}{{\sum }_{k = 1}^{N} exp ( {t}_{j} \cdot {\tilde{ι}}_{k} / τ ) )} ) + ( 1 - α ) * ( - \frac{1}{N} {\sum }_{j = 1}^{N} log \frac{exp ( {t}_{j} \cdot {\tilde{ι}}_{N - j} / τ )}{{\sum }_{k = 1}^{N - 1} exp ( ( {t}_{j} \cdot {\tilde{ι}}_{N - j} / τ ) )} ) \qquad ( 2 B )$$

where [symbol] _{T2Ĩ} represents the loss value.

In some embodiments, gradient backpropagation and updates of parameter values of the contrastive learning model, including updates of the parameter values of the encoders 410 and 420, may be performed based on the sum of loss values [symbol] _{Ĩ2T} and [symbol] _{LT2Ĩ}. For the features of correlated sample pairs in a training batch, other N−1 samples as the negative samples of the current sample may be used to calculate the contrastive learning loss, so that the similarity between the features of related sample pairs is higher, while the similarity between the features of unrelated sample pairs is lower. Based on the determined loss value, the parameter values of the encoder may be updated using a random gradient descent algorithm.

In some embodiments, for the current sample set including N sample pairs, the mixed samples and their related sample pairs obtained through mixing may form a training batch of the original N sample pairs together to update the parameter values of the contrastive learning model.

In some embodiments, if sample mixing is to be performed on the second modality, at block 350, the model training system 150 generates at least one second mixed sample of the second modality by mixing at least one pair of second samples among the plurality of second samples in the sample set.

For a certain sample set, according to the principle of the embodiment of the present disclosure, if it is determined to perform mixing on the samples of the second modality, sample mixing will not be performed on the first sample of the first modality in the sample set.

FIG. 4C illustrates the structure of the machine learning model based on contrastive learning according to some embodiments of the present disclosure. In the example of FIG. 4C, it is assumed that the samples of the second modality in a sample set will be mixed, and the contrastive learning model 400 will be trained based on the mixed results. In this example, a mixing module 422 in the contrastive learning model 400 is configured to perform sample mixing for the second modality.

In some embodiments, it is assumed that the first modality is image modal, and the encoder 410 is an encoder for image modal, and mixing may be performed on an image basis, as shown in the example of FIG. 4B. Image mixing may include, for example, the mixing of corresponding pixels, or any other appropriate image mixing way may be applied. In some embodiments, it is assumed that the second modality is a text modality and the encoder 420 is an encoder for the text modality. Considering that mixing the text itself (for example characters in the text) may be meaningless, mixing may be performed based on the feature representation of the text sample. Such mixing is sometimes referred to as manifold mixup. As shown in FIG. 4C, for the second modality (for example, text modal), the mixing module 422 is deployed behind the encoder 420 to mix the features output by the encoder 420.

Specifically, in a sample set including N sample pairs, a pair of samples indicated by label information as being related to each other is represented as (Iⱼ, Tⱼ), for example (image sample j, text sample j). In some embodiments, N samples of the second modality in the sample set may be numbered sequentially, and the corresponding samples may be mixed after being flipped in the numbering sequence to obtain N mixed samples of the second modality, as shown in the example in FIG. 2A.

For a pair of second samples Tⱼ and T_{N-j} to be mixed in the second modality (where the value of j may be from 1 to N), the samples may be input to the encoder 420 respectively to extract the corresponding pair of features tⱼ=f_{T}(Tⱼ) and iN₋ⱼ=f_{T}(T_{N-j}). The mixing module 420 is configured to, based on the mixing weight α mix these two features, generate mixed features \tilde{t}ⱼα*tⱼ+(1−α)*t_{N-j}, where α is the mixing weight applied to the sample Tⱼ (feature tⱼ). The mixed feature may characterize the corresponding mixed samples under the second modality. In some embodiments, the mixing module 422 may also apply the mixing weight α to the feature t_{N-j} corresponding to sample T_{N-j}, apply the mixing weight (1−α) to the feature tⱼ corresponding to the sample Tⱼ and obtain another mixed feature to represent another mixed sample under the second modality.

In the embodiments of the present disclosure, for the mixed samples, the corresponding mixed label information may be determined. For the at least one second mixed sample of the second modality, the corresponding second mixed label information indicates that a second mixed sample is related to a pair of first samples of the first modality that are related to a pair of second samples used for mixing the second mixed sample of the second modality. For example, for mixed samples characterized by mixed feature \tilde{t}ⱼ, samples Iⱼ and I_{N-j} of the first modality corresponding to samples Tⱼ and T_{N-j}, which are used for mixing the mixed samples, may be labeled as relevant samples of mixed samples characterized by mixed feature \tilde{t}ⱼ. Therefore, the goal of contrastive learning is to make the similarity between features iⱼ and i_{N-j} of samples Iⱼ and I_{N-j} and mixed feature \tilde{t}ⱼ as large as possible.

At block 360, the model training system 150 trains the contrastive learning model at least based on the at least one second mixed sample and second mixed label information. The second mixed label information indicates that the second mixed sample is related to a pair of first samples of the first modality that are related to a pair of second samples used for mixing the second mixed sample of the second modality.

In the training process, the mixed samples of the second modality and the related samples of the first modality are input to the encoders 420 and 410 respectively, as shown in FIG. 4C. For the encoder 410 of the first modality, it still processes the first sample under the unmixed first modality, including samples Iⱼ and I_{N-j}. For the second modality, the feature t j corresponding to the mixed samples may be obtained.

When sample mixing is performed for the second modality, the mixed sample set may be used to determine the loss value of the corresponding mixed contrastive loss function 442. The calculation way of the loss value of the mixed contrastive loss function 442 is similar to the way of the loss value of the mixed contrastive loss function 441 in the example in FIG. 4B and will not be repeated.

In some embodiments, for the first part (for example, the part from image to text) of the mixed contrastive loss function 442 from the first modality to the second modality, the loss value may be determined as follows:

$${ℒ}_{I 2 \tilde{T}} = α * ( - \frac{1}{N} {\sum }_{j = 1}^{N} log \frac{exp ( {i}_{j} \cdot {\tilde{t}}_{j} / τ )}{{\sum }_{k = 1}^{N} exp ( {i}_{j} \cdot {\tilde{t}}_{k} / τ )} ) + ( 1 - α ) * ( - \frac{1}{N} {\sum }_{j = 1}^{N} log \frac{exp ( {i}_{j} \cdot {\tilde{t}}_{N - j} / τ )}{{\sum }_{k = 1}^{N - 1} exp ( {i}_{j} \cdot {\tilde{t}}_{N - k} / τ )} ) \qquad ( 3 A )$$

where [symbol] _{I2\tilde{T}} represents the loss value.

In some embodiments, for the second part of the mixed contrastive loss function from the second modality to the first modality, the loss value may be determined as follows:

$${ℒ}_{\tilde{T} 2 I} = α * ( - \frac{1}{N} {\sum }_{j = 1}^{N} log \frac{exp ( {\tilde{t}}_{j} \cdot {i}_{j} / τ )}{{\sum }_{k = 1}^{N} exp ( {\tilde{t}}_{j} \cdot {i}_{k} / τ )} ) + ( 1 - α ) * ( - \frac{1}{N} {\sum }_{j = 1}^{N} log \frac{exp ( {\tilde{t}}_{j} \cdot {i}_{N - j} / τ )}{{\sum }_{k = 1}^{N - 1} exp ( {\tilde{t}}_{j} \cdot {i}_{N - k} / τ )} ) \qquad ( 3 B )$$

where [symbol] _{\tilde{T}2I} represents the loss value.

In some embodiments, gradient backpropagation and updates of parameter values of the contrastive learning models, including updates of the parameter values of the encoders 410 and 420, may be performed based on the sum of loss values [symbol] _{I2\tilde{T}} and [symbol] _{\tilde{T}2I}. For the features of correlated sample pairs in a training batch, other N−1 samples as the negative samples of the current sample may be used to calculate the contrastive learning loss, so that the similarity between the features of related sample pairs is higher, while the similarity between the features of unrelated sample pairs is lower. Based on the determined loss value, the parameter values of the encoder may be updated using a random gradient descent algorithm.

In some embodiments, for the current sample set including N sample pairs, the mixed samples and their related sample pairs obtained through mixing may form a training batch of the original N sample pairs together to update the parameter values of the contrastive learning model.

Note that in the above example, although it is shown that the sample mixing for the first modality and the second modality is based on the mixing weight α, however, different mixing weights may be set for different modalities, or different mixing weights may be set for different sample sets, as long as the corresponding mixing weights are used to determine the loss value in the contrastive loss function.

According to the embodiments of the present disclosure, by performing sample mixing of a single modality according to the training set, additional training data may be created, the richness of the data may be improved, and thus the performance of the trained model may be improved. Moreover, linear constraints may be introduced into the learning of the model, and the problem of label allocation for mixed samples can be avoided. In addition, for text modality sample mixing may be performed at the output end of the encoder, while for image modal, sample mixing may be performed at the input end of the encoder. This differentiated sample mixing way may improve the mixing effect of different modalities.

In some embodiments, the contrastive learning model trained based on one or more embodiments described above may be provided for use by downstream tasks. Downstream tasks may include at least one of the following: a first unimodal downstream task for the first modality, a second unimodal downstream task for the second modality, and a cross-modal downstream task for the first modality and the second modality. In the downstream task, the encoder for the first modality and/or the second modality in the contrastive learning model may be used to extract the features of the task corresponding to the modal. The application of the encoder may, for example, be executed by the model application system 160 in FIG. 1. The extracted features may be used to determine prediction results in downstream tasks. Depending on the specific application needs, in downstream tasks, the parameter values of the first encoder and/or second encoder may also be further tuned for specific tasks. The output of the first encoder and/or second encoder may be connected to another model for further processing. The embodiments of the present disclosure are not limited in this regard.

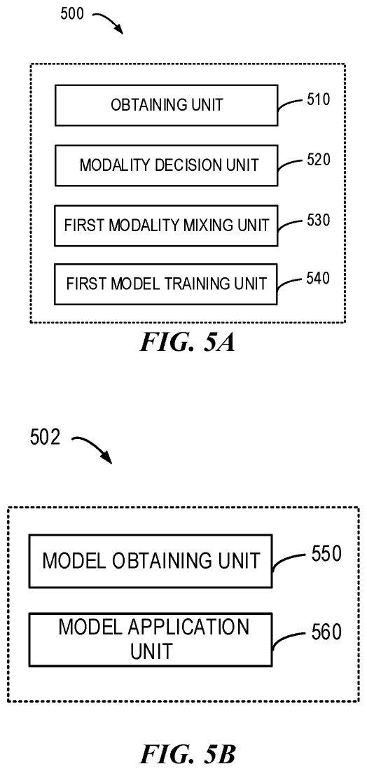

FIG. 5A illustrates a block diagram of an apparatus 500 for training the contrastive learning model according to some embodiments of the present disclosure. The apparatus 500, for example, may be implemented or included in the model training system 150. Each module/component in the apparatus 500 may be implemented by hardware, software, firmware, or any combination of them.

As shown in the figure, the apparatus 500 includes an obtaining unit 510 configured to obtain a sample set and label information for training a contrastive learning model. The sample set comprising a plurality of first samples of a first modality and a plurality of second samples of a second modality. The label information indicating a correlation between samples of the plurality of first samples and samples of the plurality of second samples. The apparatus 500 further includes a modality decision unit 520 configured to determine whether sample mixing is to be performed on the first modality or the second modality for the sample set.

The apparatus 500 further includes a first modality mixing unit 530 configured to, in accordance with a determination that sample mixing is to be performed on the first modality, generate at least one first mixed sample of the first modality by mixing at least one pair of first samples among the plurality of first samples in the sample set. The apparatus 500 further includes a first modality training unit 540 configured to train the contrastive learning model at least based on the at least one first mixed sample and first mixed label information. The first mixed label information indicating that a first mixed sample is related to a pair of second samples of the second modality that are related to a pair of first samples used for mixing the first mixed sample of the first modality.

In some embodiments, for the sample set, mixing is performed on the plurality of first samples without performing sample mixing on the plurality of second samples.

In some embodiments, the apparatus 500 further includes: a second modality mixing unit configured to, in accordance with a determination that sample mixing is to be performed on the second modality, generate at least one second mixed sample of the second modality by mixing at least one pair of second samples among the plurality of second samples in the sample set; and a second modality training unit configured to the contrastive learning model at least based on the at least one second mixed sample and second mixed label information, the second mixed label information indicating that a second mixed sample is related to a pair of first samples of the first modality that are related to a pair of second samples used for mixing the second mixed sample of the second modality.

In some embodiments, the second modality comprises a text modality and the contrastive learning model comprises an encoder for the text modality and wherein the second modality mixing unit comprises: for a given pair of second samples, a feature extraction unit configured to extract features of the given pair of second samples respectively using the encoder for the text modality in the contrastive learning model, to obtain a pair of second features; and a feature mixing unit configured to generate a mixed feature by mixing the pair of second features to characterize a second mixed sample.

In some embodiments, the modality decision unit 520 includes a sampling unit configured to obtain a sampling value from a predetermined uniform distribution; a comparison unit configured to compare the sampling value with a predetermined threshold; and a first determination unit configured to, in accordance with a determination that a result of the comparison is a first comparison result, determine that sample mixing is to be performed on the first modality.

In some embodiments, the mode determination unit 520 further includes: a second determination unit configured to, in accordance with a determination that a result of the comparison is a second comparison result, determine that sample mixing is to be performed on the second modality.

In some embodiments, the sample set comprises a sample set of a training batch for the contrastive learning model.

In some embodiments, the first modality training unit 540 includes: a prediction determination unit configured to determine a prediction related result for the at least one first mixed sample using the contrastive learning model; a loss value determination unit configured to determine a loss value of a contrastive loss function based on a difference between the prediction related result and the first mixed label information; and a parameter value update unit configured to update parameter values of the contrastive learning model based on the loss value.

In some embodiments, the first modality comprises any of a plurality of modalities in the following: image, text, video, audio, and wherein the second modality comprises a further one of the plurality of modalities.

FIG. 5B illustrates a block diagram of an apparatus 502 for training the contrastive learning model according to some embodiments of the present disclosure. The apparatus 502, for example, may be implemented or included in the model application system 160. Each module/component in apparatus 502 may be implemented by hardware, software, firmware, or any combination of them.

As shown in the figure, the apparatus 502 includes a model obtaining unit 550 configured to obtain the contrastive learning model trained according to some embodiments of the present disclosure or the apparatus 500. The apparatus 502 further includes a model application unit 560 configured to apply the contrastive learning model in at least one downstream task comprising at least one of the following: a first unimodal downstream task for the first modality, a second unimodal downstream task for the second modality, a cross-modal downstream task for the first modality and the second modality.

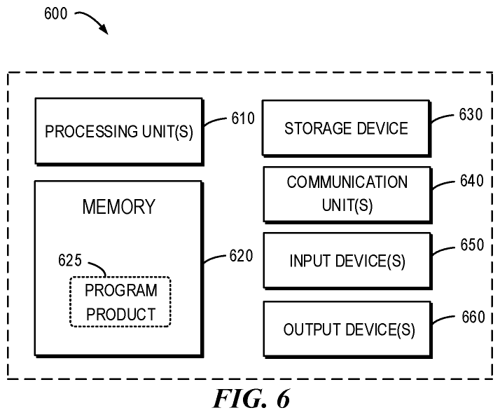

FIG. 6 illustrates a block diagram of an electronic device 600 in which one or more embodiments of the present disclosure may be implemented. It should be understood that the electronic device 600 shown in FIG. 6 is only an example and should not constitute any limitation on the functionality and scope of the embodiments described herein. The electronic device 600, for example, may be used to implement the model training system 150 and/or the model application system 160.

As shown in FIG. 6, the electronic device 600 is in the form of a general computing device. The components of electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and can execute various processes based on the programs stored in the memory 620. In a multiprocessor system, multiple processing units execute computer executable instructions in parallel to improve the parallel processing capability of the electronic device 600.

The electronic device 600 typically includes multiple computer storage medium. Such medium may be any available medium that is accessible to the electronic device 600, including but not limited to volatile and non-volatile medium, removable and non-removable medium. The memory 620 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 630 may be any removable or non-removable medium, and may include a machine readable medium such as a flash drive, a disk, or any other medium, which may be used to store information and/or data (such as training data for training) and may be accessed within the electronic device 600.

The electronic device 600 may further include additional removable/non-removable, volatile/non-volatile storage medium. Although not shown in FIG. 6, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 620 may include a computer program product 625, which has one or more program units configured to perform various methods or acts of various embodiments of the present disclosure.

The communication unit 640 communicates with a further electronic device through the communication medium. In addition, functions of components in the electronic device 600 may be implemented by a single computing cluster or multiple computing machines, which can communicate through a communication connection. Therefore, the electronic device 600 may be operated in a networking environment using a logical connection with one or more other servers, a network personal computer (PC), or another network node.

The input device 650 may be one or more input devices, such as a mouse, a keyboard, a trackball, etc. The output device 660 may be one or more output devices, such as a display, a speaker, a printer, etc. The electronic device 600 may also communicate with one or more external devices (not shown) through the communication unit 640 as required. The external device, such as a storage device, a display device, etc., communicate with one or more devices that enable users to interact with the electronic device 600, or communicate with any device (for example, a network card, a modem, etc.) that makes the electronic device 600 communicate with one or more other electronic devices. Such communication may be executed via an input/output (I/O) interface (not shown).

According to example implementation of the present disclosure, a computer-readable storage medium is provided, on which a computer-executable instruction or computer program is stored, wherein the computer-executable instructions is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the apparatus, the device and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, specialized computers or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium containing the instructions includes a product, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps may be performed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a unit, a program segment or instructions, which contains one or more executable instructions for implementing the specified logic function. In some alternative implementations, the functions labeled in the block may also occur in a different order from those labeled in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is an example, not exhaustive, and is not limited to the disclosed implementations. Without departing from the scope and spirit of the described implementations, many modifications and changes are obvious to ordinary skill in the art. The selection of terms used in the present disclosure aims to best explain the principles, practical application or improvement of technology in the market of each implementation, or to enable other ordinary skill in the art to understand the various embodiments disclosed herein.

What is claimed is:

1. A method for training a contrastive learning model, comprising:
obtaining a sample set and label information for training a contrastive learning model, the sample set comprising a plurality of first samples of a first modality and a plurality of second samples of a second modality, the label information indicating a correlation between samples of the plurality of first samples and samples of the plurality of second samples;
determining whether sample mixing is to be performed on the first modality or the second modality for the sample set;
in accordance with a determination that sample mixing is to be performed on the first modality, generating at least one first mixed sample of the first modality by mixing at least one pair of first samples among the plurality of first samples in the sample set; and
training the contrastive learning model at least based on the at least one first mixed sample and first mixed label information, the first mixed label information indicating that a first mixed sample is related to a pair of second samples of the second modality that are related to a pair of first samples used for mixing the first mixed sample of the first modality.

2. The method of claim 1, wherein for the sample set, mixing is performed on the plurality of first samples without performing sample mixing on the plurality of second samples.

3. The method of claim 1, further comprising:
in accordance with a determination that sample mixing is to be performed on the second modality, generating at least one second mixed sample of the second modality by mixing at least one pair of second samples among the plurality of second samples in the sample set; and
training the contrastive learning model at least based on the at least one second mixed sample and second mixed label information, the second mixed label information indicating that a second mixed sample is related to a pair of first samples of the first modality that are related to a pair of second samples used for mixing the second mixed sample of the second modality.

4. The method of claim 3, wherein the second modality comprises a text modality and the contrastive learning model comprises an encoder for the text modality and
wherein generating the at least one second mixed sample comprises: for a given pair of second samples,
extracting features of the given pair of second samples respectively using the encoder for the text modality in the contrastive learning model, to obtain a pair of second features; and
generating a mixed feature by mixing the pair of second features to characterize a second mixed sample.

5. The method of claim 1, wherein determining whether sample mixing is to be performed on the first modality or the second modality comprises:
obtaining a sampling value from a predetermined uniform distribution;
comparing the sampling value with a predetermined threshold; and
in accordance with a determination that a result of the comparison is a first comparison result, determining that sample mixing is to be performed on the first modality.

6. The method of claim 5, further comprising:
in accordance with a determination that a result of the comparison is a second comparison result, determining that sample mixing is to be performed on the second modality.

7. The method of claim 1, wherein the sample set comprises a sample set of a training batch for the contrastive learning model.

8. The method of claim 1, wherein training the contrastive learning model comprises:
determining a prediction related result for the at least one first mixed sample using the contrastive learning model;
determining a loss value of a contrastive loss function based on a difference between the prediction related result and the first mixed label information; and
updating parameter values of the contrastive learning model based on the loss value.

9. The method of claim 1, wherein the first modality comprises any of a plurality of modalities in the following: image, text, video, audio, and wherein the second modality comprises a further one of the plurality of modalities.

10. The method of claim 1, further comprising:
obtaining the trained contrastive learning model; and
applying the contrastive learning model in at least one downstream task comprising at least one of the following:
a first unimodal downstream task for the first modality,
a second unimodal downstream task for the second modality,
a cross-modal downstream task for the first modality and the second modality.

11. An electronic device, comprising:
at least one processing unit; and
at least one memory coupled to the at least one processing unit and storing instructions to be executed by the at least one processing unit, the instructions, when executed by the at least one processing unit, causing the device to perform the following acts:
obtaining a sample set and label information for training a contrastive learning model, the sample set comprising a plurality of first samples of a first modality and a plurality of second samples of a second modality, the label information indicating a correlation between samples of the plurality of first samples and samples of the plurality of second samples;
determining whether sample mixing is to be performed on the first modality or the second modality for the sample set;
in accordance with a determination that sample mixing is to be performed on the first modality, generating at least one first mixed sample of the first modality by mixing at least one pair of first samples among the plurality of first samples in the sample set; and
training the contrastive learning model at least based on the at least one first mixed sample and first mixed label information, the first mixed label information indicating that a first mixed sample is related to a pair of second samples of the second modality that are related to a pair of first samples used for mixing the first mixed sample of the first modality.

12. The device of claim 11, wherein for the sample set, mixing is performed on the plurality of first samples without performing sample mixing on the plurality of second samples.

13. The device of claim 11, wherein the acts further comprise:
in accordance with a determination that sample mixing is to be performed on the second modality, generating at least one second mixed sample of the second modality by mixing at least one pair of second samples among the plurality of second samples in the sample set; and
training the contrastive learning model at least based on the at least one second mixed sample and second mixed label information, the second mixed label information indicating that a second mixed sample is related to a pair of first samples of the first modality that are related to a pair of second samples used for mixing the second mixed sample of the second modality.

14. The device of claim 13, wherein the second modality comprises a text modality and the contrastive learning model comprises an encoder for the text modality and
wherein generating the at least one second mixed sample comprises: for a given pair of second samples,
extracting features of the given pair of second samples respectively using the encoder for the text modality in the contrastive learning model, to obtain a pair of second features; and
generating a mixed feature by mixing the pair of second features to characterize a second mixed sample.

15. The device of claim 11, wherein determining whether sample mixing is to be performed on the first modality or the second modality comprises:
obtaining a sampling value from a predetermined uniform distribution;
comparing the sampling value with a predetermined threshold; and
in accordance with a determination that a result of the comparison is a first comparison result, determining that sample mixing is to be performed on the first modality.

16. The device of claim 15, wherein the acts further comprise:
in accordance with a determination that a result of the comparison is a second comparison result, determining that sample mixing is to be performed on the second modality.

17. The device of claim 11, wherein the sample set comprises a sample set of a training batch for the contrastive learning model.

18. The device of claim 11, wherein training the contrastive learning model comprises:
determining a prediction related result for the at least one first mixed sample using the contrastive learning model;
determining a loss value of a contrastive loss function based on a difference between the prediction related result and the first mixed label information; and
updating parameter values of the contrastive learning model based on the loss value.

19. The device of claim 11, wherein the first modality comprises any of a plurality of modalities in the following: image, text, video, audio, and wherein the second modality comprises a further one of the plurality of modalities.

20. A non-transitory computer-readable storage medium having a computer program stored thereon which, when executed by a processor, performs the method for training a contrastive learning model, the method comprising:
obtaining a sample set and label information for training a contrastive learning model, the sample set comprising a plurality of first samples of a first modality and a plurality of second samples of a second modality, the label information indicating a correlation between samples of the plurality of first samples and samples of the plurality of second samples;
determining whether sample mixing is to be performed on the first modality or the second modality for the sample set;
in accordance with a determination that sample mixing is to be performed on the first modality, generating at least one first mixed sample of the first modality by mixing at least one pair of first samples among the plurality of first samples in the sample set; and
training the contrastive learning model at least based on the at least one first mixed sample and first mixed label information, the first mixed label information indicating that a first mixed sample is related to a pair of second samples of the second modality that are related to a pair of first samples used for mixing the first mixed sample of the first modality.
